(19) United States
(12) Patent Application Publication
(10) Pub. No.: US 2014/0340881 A1
(43) Pub. Date: Nov. 20, 2014

(54) ELECTRONIC SIMULATION CANDLE

(71) Applicant: Kayee Trading (Shenzhen) Co., Ltd., Shenzhen (CN)

(72) Inventor: Mao-Bang Tsai, Shenzhen (CN)

(73) Assignee: Kayee Trading (Shenzhen) Co., Ltd., Shenzhen (CN)

(21) Appl. No.: 13/897,887

(22) Filed: May 20, 2013

(51) Int. Cl. F21L 4/00

(52) U.S. Cl. CPC F21L 4/00
USPC 362/190

(57) ABSTRACT

An electronic simulation candle includes a lamp wick, a lamp wick support and a circuit assembly. The lamp wick includes a flame sheet at an upper portion, a neck at a middle portion and a support sheet at a lower portion, the neck comprises a through hole, a center of gravity of the lamp wick is below the through hole. The lamp wick is fixed to the lamp wick support only with an elongated supporting element extending through the through hole, and the flame sheet is exposed outside the lamp wick support. The flame sheet of the lamp wick is free for swinging with wind or air flow, such that the flame sheet swings similar to a conventional flame, thereby the degree of simulation is improved.

### FIELD OF THE INVENTION

The present invention relates to candles, and particularly to an electronic simulation candle.

### BACKGROUND OF THE INVENTION

Candles are mainly used for lighting and decorating. With people's ongoing environmental protection awareness and aesthetic level, the conventional combustion types of candles are being replaced by electronic simulation candles. Such electronic simulation candles mainly use external power supply or internal batteries to provide power supply for light emitting elements, and use light emitted from the light emitting elements to simulate flame of conventional candles.

Conventional candles may have flame pulsation and flicker, however electronic light emitting elements generating lights to simulate flame usually give static light, such that the simulation is not so good which impacts people's visual experience.

### SUMMARY

The present invention is to provide an electronic simulation candle which can improve the simulation degree.

An electronic simulation candle includes a lamp wick, a lamp wick support, a light emitting element and a circuit assembly. The lamp wick includes a flame sheet at an upper portion, a neck at a middle portion and a support sheet at a lower portion. Wherein, the neck has a through hole, the centre of gravity of the lamp wick is below the through hole. The lamp wick is fixed to lamp wick support only with an elongated supporting element extending through the through hole, and the flame sheet is exposed outside the lamp wick support.

The elongated supporting element is a flexible wire.

The flame sheet is a thin plastic sheet.

The lamp wick support includes two half-shells, each of the half-shells includes a half-ring disposed on the half-shell and a shell portion supporting the half-ring and connecting to half-ring. Each of the shell portions has an incline surface connecting to the internal portion of the shell portion and the half-ring. The light emitting element is fixed at the two incline surfaces and emits light toward the lamp wick.

Each of the incline surfaces has an incline angle in a range of 30-40 degrees relative to the central axis of the lamp wick support.

Beneficial effects of the present invention are: due to the lamp wick being only attached by an elongated supporting element and fixed to the lamp wick support, the flame sheet of the lamp wick is free resulting in swinging with wind or air flow, to simulate flame pulsation and flicker, thereby improving the degree of simulation. No other driving force is needed for the swing of the flame sheet, therefore it is an environmental protection and energy saving electronic simulation candle.

### BRIEF DESCRIPTION OF THE DRAWINGS

Here below the drawings and embodiments are incorporated to further describe the electronic simulation candle.

FIG. 1 shows a schematic exploded view of an electronic simulation candle according to one embodiment of the present invention.

FIG. 2 shows an opposite view of FIG. 1.

FIG. 3 shows a partially assembled view of FIG. 1.

FIG. 4 shows a cut-away view of the assembled electronic simulation candle of FIG. 3.

### DETAILED DESCRIPTION

Hereafter embodiments are combined with the drawings to further describe the present invention.

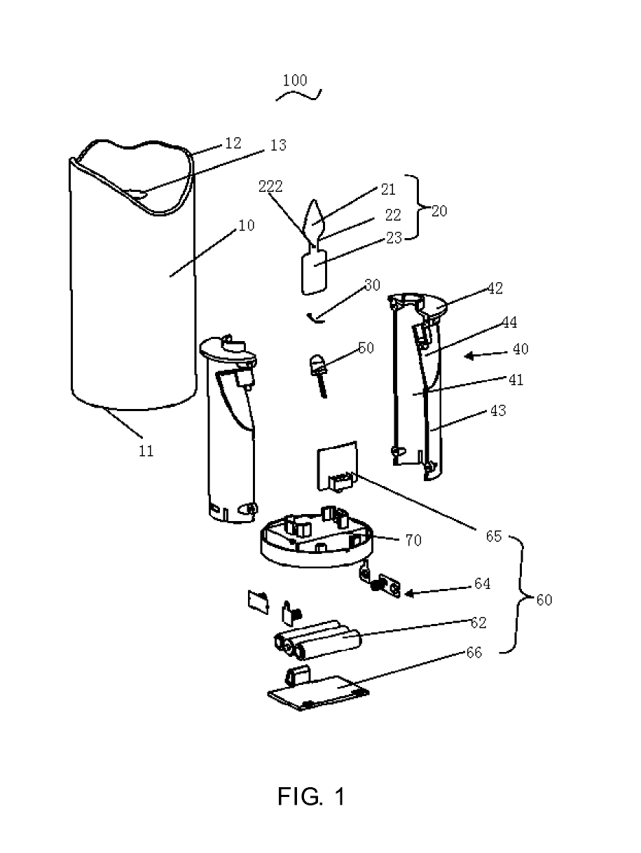

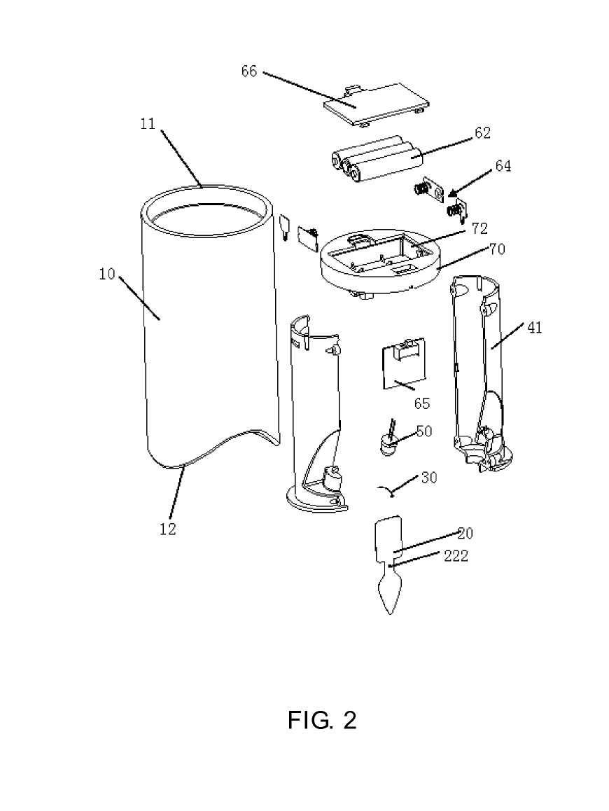

Referring to FIG. 1 and FIG. 2, an electronic simulation candle 100 provided by the present embodiment includes a candle barrel 10, a lamp wick 20 disposed inside the candle barrel 10, an elongated supporting element 30, a lamp wick support 40, a light emitting element 50, a circuit assembly 60 and a base 70.

The lamp wick 20 includes a flame sheet 21 at an upper portion, a neck 22 at a middle portion and a support sheet 23 at a lower portion. The neck 22 has a through hole 222 for the elongated hanging element 30 extending therethrough. The lamp wick 20 can be chosen to be red color, yellow color or white color as needed, the color of the lamp wick 20 incorporated with a color of the light emitted from the light emitting element 50 shall be similar to an actual flame. Preferably, the flame sheet 21 is a thin plastic sheet, therefore swinging more easily. In other embodiments, the flame sheet 21 can be paper-made.

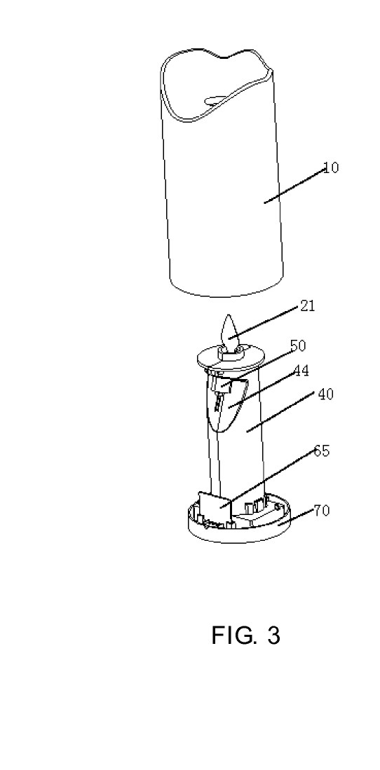

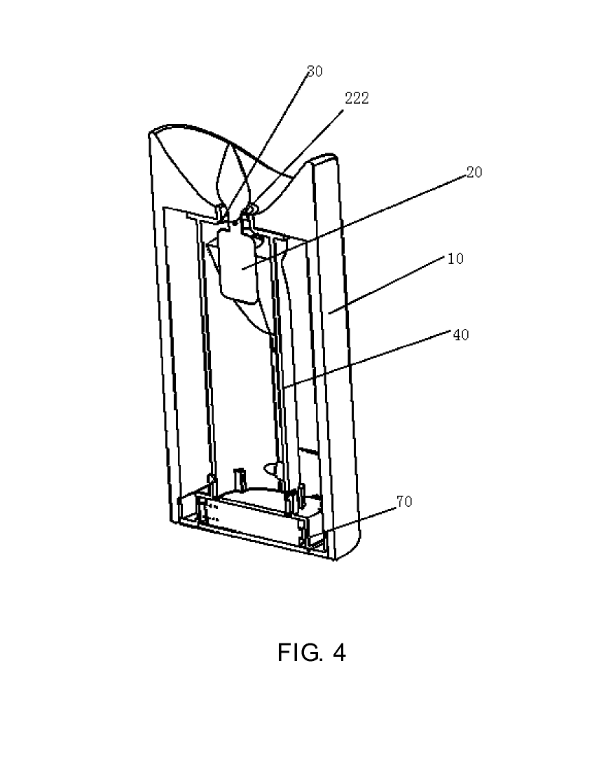

Referring to FIG. 3 and FIG. 4, the lamp wick support 40 includes two half-shells 41. Each of the half-shells 41 includes a half-ring 42 disposed at the upper end of the half-shell 41 and a shell portion 43 supporting the half-ring 42 and connecting to the half-ring 42. Each of the shell portions 43 has an incline surface 44 connecting to the internal portion of the half-shell 41 and the half-ring 42. Each of the incline surfaces 44 has an incline angle in a range from 30 to 40 degrees relative to the central axis of the lamp wick support 40.

In the present embodiment, the elongated supporting element 30 is a flexible wire. Two ends of the elongated supporting element 30 are fixed to internal portion of the lamp wick support 40. Due to only being supported by the elongated supporting element 30, the flame sheet 21 of the lamp wick 20 is free for swinging with wind or air flow, simulating the flame pulsation and flicker, thereby the degree of simulation is improved.

The incline surfaces 44 of the lamp wick support 40 are used to fix light emitting element 50, thereby facilitating the mounting of the light emitting element 50. The light emitting element 50 can be LED. The incline surfaces 44 are connected to the lamp wick support 40 and the half-ring 42, thereby the light emitting element 50 can emit light toward the lamp wick 20. In addition, as the incline surfaces 44 has an incline angle of 30-40 degrees, the light emitting element 50 can emit light toward the flame sheet 21.

The circuit assembly 60 includes a group of batteries 62 supplying power to the light emitting element 50, a plurality of electrode plate 64, a printed circuit board 65 and a cover 66. The cover 66 also acts as the bottom plate of the base 70.

The bottom of the base 70 is provided with a battery receiving compartment 72. The plurality of electrode plates 64 and the printed circuit board 65 are mounted to the base 70 with insertion, and the lamp wick support 40 is mounted on the base 70.

A bottom end 11 of the candle barrel 10 is flat, and an upper end 12 of the candle barrel 10 is wave-shaped. An opening 13 is defined through the upper end 12, such that the flame sheet 21 can extend through the opening 13. The candle barrel 10 can be made of plastic material, and a color thereof can be selected as needed, for example, red or yellow which is similar to a conventional candle. The base 70 is located at the bottom end 11 of the candle barrel 10.

In other embodiments, the candle barrel 10 and the base 70 can be omitted, and the circuit assembly 60 can be mounted on the lamp wick support 40.

In addition, it could be understood that the elongated supporting element 30 is not necessary to be always flexible, and hard textured supporting element can also be used.

The swing of the lamp wick 20 does not need extra driving forces, such that it is an environmental protection and energy saving electronic simulation candle.

The above description is only the preferred embodiments of the present invention, which aim at helping to understand the present invention and not intend to limit the present invention. One skilled in the art can do modifications according to the spirit of the present invention.

1. An electronic simulation candle comprising:
a lamp wick;
a lamp wick support; and
a circuit assembly, wherein the lamp wick comprises a flame sheet at an upper portion, a neck at a middle portion and a support sheet at a lower portion, the neck comprises a through hole, a center of gravity of the lamp wick is below the through hole, the lamp wick is fixed to the lamp wick support only with an elongated supporting element extending through the through hole, and the flame sheet is exposed outside the lamp wick support.

2. The electronic simulation candle of claim 1, wherein the elongated hanging element is a flexible wire.

3. The electronic simulation candle of claim 1, wherein the flame sheet is a thin plastic sheet.

4. The electronic simulation candle of claim 1, wherein the lamp wick support comprises two half-shells, each of the half-shells comprising a half-ring disposed on the upper portion of the half-shell and a shell supporting portion supporting the half-ring and connecting to the half-ring, each of the shell supporting portions comprises an incline surface connecting to the internal portion of the shell supporting portion and half-shell, the light emitting element is fixed at the two incline surfaces and emits light toward the lamp wick.

5. The electronic simulation candle of claim 4, wherein each of the incline surfaces has an incline angle in a range from 30 to 40 degrees relative to a central axis of the lamp wick support.

6. The electronic simulation candle of claim 1, wherein the light emitting element is an LED.

7. The electronic simulation candle of claim 1, wherein the circuit assembly comprises a printed circuit board, a group of batteries and a plurality of electrode plates, the batteries supply power to the light emitting element.

8. The electronic simulation candle of claim 1, further comprising a base, the circuit assembly and the lamp wick support are mounted on the base.

9. The electronic simulation candle of claim 8, wherein the circuit assembly further comprises a candle barrel receiving the lamp wick, the lamp wick support, the light emitting element, the circuit assembly and the base, the candle barrel has an opening at an upper end, the flame sheet extends through the opening.
